(19) United States
(12) Patent Application Publication
(10) Pub. No.: US 2015/0104275 A1
(43) Pub. Date: Apr. 16, 2015

(54) Lifting Apparatus

(71) Applicant: Helix Energy Solution (U.K.) Limited, Aberdeen (GB)

(72) Inventors: Leigh Beck, Aberdeenshire (GB); Philip Bosworth, Aberdeen (GB); Eddie Wood, Aberdeen (GB)

(21) Appl. No.: 14/395,324

(22) PCT Filed: Apr. 18, 2013
(86) PCT No.: PCT/GB2013/050978

§ 371 Date: Oct. 17, 2014

(30) Foreign Application Priority Data
Apr. 18, 2012 (GB) 1206805.2

(51) Int. Cl. B66C 13/04; B63B 27/16

(52) U.S. Cl. CPC B66C 13/04; B63B 27/16
USPC 414/141.7; 414/803; 254/385

(57) ABSTRACT

A lifting method comprising supporting a payload (20) using a first lifting apparatus (18); and activating an emergency lifting apparatus (14) to raise the payload a predetermined distance in response to an emergency signal. The emergency lifting apparatus is configured to be activated to lift the payload a predetermined distance in response to an emergency activation signal. The method and apparatus are particularly useful in the event of a failure of the first lifting apparatus: the emergency lifting apparatus may be activated to lift the payload a relatively small distance sufficient to clear adjacent structures. This may be particularly advantageous in offshore operations, where the first lifting apparatus is supported on a floating vessel which will experience heave.

### FIELD OF THE INVENTION

This invention relates to lifting apparatus, and to a lifting method. The apparatus has particular utility in offshore lifting operations, where the lifting takes place from a floating vessel, and may be utilised in the event of failure of a main winch or the like.

### BACKGROUND OF THE INVENTION

In offshore operations, such as in the oil and gas industry or in the construction or maintenance of offshore wind farms, operators regularly deploy (and recover) equipment payloads to and from fixed infrastructure equipment on the seabed. The deployments may be made using a wide range of equipment. In one arrangement a subsea winch is mounted upon a floating vessel (rig and ship). In the event of a winch failure, the payload may be suspended from the vessel for some time, until the winch is repaired or other steps are taken to retrieve the payload.

### SUMMARY OF THE INVENTION

According to a first aspect of the present invention there is provided a lifting method comprising:

supporting a payload using a first lifting apparatus;

activating an emergency lifting apparatus to raise the payload a predetermined distance in response to an emergency signal.

According to a second aspect of the present invention there is provided emergency lifting apparatus for use in association with a first lifting apparatus for supporting a payload, the emergency lifting apparatus being configured to be activated to lift the payload a predetermined distance in response to an emergency activation signal.

These aspects of the invention may have utility in a variety of circumstances. For example, in the event of a failure of the first lifting apparatus, the emergency lifting apparatus may be activated to lift the payload a relatively small distance sufficient to clear adjacent structures. This may be particularly advantageous in offshore operations, where the first lifting apparatus is supported on a floating vessel which will experience heave. If a lifting apparatus failure occurs as the payload is located adjacent fixed infrastructure on the seabed there is a danger that heave of the supporting vessel, or indeed any other movement, will result in the payload impacting on the infrastructure. Such an impact may have significant safety implications, as well as the potential for enormously expensive damage and delay.

The first lifting apparatus may take any appropriate form and may be mounted on any appropriate support or structure. However, as noted above, the invention offers particular advantages in relation to lifting apparatus mounted on floating vessels, or other supports (or sites) which may be subject to movement.

The first lifting apparatus may include an elongate support, such as a lifting wire. The first lifting apparatus may be associated with one or more winches, and in one embodiment a subsea winch may be provided.

The emergency signal may be generated automatically, for example in response to a system failure, or in response to a supporting vessel detecting or predicting an extreme condition, such as a severe gust of wind or abnormally large wave. Alternatively, or in addition, the emergency signal may be triggered by an operator in response to an observed or anticipated event, for example a failure in an associated system or an observation of a dangerous or otherwise undesirable event.

The emergency lifting apparatus may take any appropriate form. The apparatus may be configured to act on a flexible elongate support, such as a wire, cable, rope or the like, and on activation may induce primarily vertical movement of the payload. The apparatus may be configured to move a portion of the support to induce a shortening or retraction of the support between the apparatus and the payload. For example, the apparatus may induce a lateral deflection in a portion of the support, which deflection is accommodated by shortening of the support between the apparatus and the payload.

The emergency lifting apparatus may include a support deflecting member which may be actuated to deflect a support member from an initial position. The deflecting member may include a sheave for contact with the support member. The sheave diameter may be selected such that contact between the sheave and the support member does not damage the support member, for example a sheave for engaging a support wire may be sized on a minimum “Did” basis (sheave to support wire diameter) to prevent or minimize wire fatigue. Of course the deflecting member may be provided with a support member contact other than a sheave, such as a suitably shaped non-rotating surface, which surface may be provided with a low-friction coating. The deflecting member may be associated with an actuator. The actuator may take any appropriate form, and may operate independently of the first lifting apparatus actuation. The actuator may comprise a piston and cylinder arrangement. Fluid for the arrangement may be supplied from any suitable source, such as an HPU or accumulator system. The actuator may be configured to provide relatively rapid actuation.

The support deflecting member may be actuated to move substantially transversely to the support member; such that the portion of the support member is laterally deflected.

The deflecting member may be provided in combination with one or more support member restraining members, or one or more further deflecting members, such that lateral deflection of the support member is translated efficiently to shortening or retraction of the support member between the lifting apparatus and the payload. The/each restraining member may comprise a support guide member.

The apparatus may be configured to prevent contact between the deflecting member/s and the support member during normal use (of the first lifting apparatus). The apparatus may be configured to prevent contact between the restraining member/s and the support member during normal use. The apparatus may be configured to press the support member against the restraining member/s by activation of the deflecting member/s.

The apparatus may comprise a liftside restraining member positioned to contact the support member at a position along the support member between the deflecting member and the first lifting apparatus upon activation of the emergency lifting apparatus. The apparatus may comprise a payload-side restraining member positioned to contact the support member at a position along the support member between the deflecting member and the payload upon activation of the apparatus. It will be appreciated that the position/s of the liftside and or payload-side restraining member/s relative to deflecting member and the first lifting apparatus and the deflecting member and the payload may be reversed depending on the configuration of the lifting apparatus (e.g. where the first lifting apparatus is located above the emergency lifting apparatus then the payload-side restraining member may be a payload-side restraining member; where the first lifting apparatus is located below the emergency lifting apparatus then the payload-side restraining member may be an upper restraining member).

The liftside and/or payload-side restraining member/s may be configured to remain substantially stationary relative to the first lifting apparatus and/or the support during activation of the emergency lifting apparatus.

The liftside and/or payload-side restraining member/s may be configured to move relative to the first lifting apparatus and/or the support during activation of the emergency lifting apparatus. For example, the liftside and/or payload-side restraining member/s may be configured to move in a direction substantially opposite to the support deflecting member upon activation of the apparatus.

The restraining member/s may include a sheave/s for contact with the support member. The sheave/s may be freely rotatable about their central axis/es. The sheave diameter/s may be selected such that contact between the sheave/s and the support member does not damage the support member. Of course the restraining member/s may be provided with a support member contact other than a sheave, such as a suitably shaped non-rotating surface, which surface may be provided with a low-friction coating.

The deflecting member and the restraining member/s may be positioned in a substantially vertical plane. The apparatus may be configured to move the deflecting member adjacent the separating member/s upon activation. The apparatus may be configured to move the deflecting member through a separation, such as an opening, between the liftside and payload-side restraining members upon activation.

The predetermined distance may correspond to a safety height, such as a predetermined distance to compensate for a maximum potential emergency drop in payload height. For example, the predetermined distance may correspond to a maximum emergency displacement of the support member, such as required by a maximum emergency displacement of the first lifting apparatus (e.g. due to a maximum heave and/or yaw and/or pitch and/or drift of a floating first lifting apparatus and/or a maximum unchecked support member payout from a failing first lifting apparatus prior to arresting the payout).

The emergency lifting apparatus may comprise a lock. For example, the deflecting member/s may be activated by an actuator, such as a hydraulic piston from an initial position to an activated position; the deflecting member being locked in the activated position, such as by a mechanical latch.

A plurality of support members may support the payload. For example, a second wire may support the payload; such as supporting the payload from the first lifting apparatus.

A plurality of lifting apparatus may support the payload in normal use. For example, a second wire may support the payload from a second lifting apparatus (e.g. a second winch).

A plurality of payloads may be supported. For example, a second support member may support a second payload. The second payload may be supported by the first lifting apparatus in normal use. The second payload may be supported by a second lifting apparatus, such as a second winch, in normal use.

An emergency lifting apparatus may be associated with the/each support member.

An emergency lifting apparatus may be associated with multiple support members.

Multiple emergency lifting apparatuses may be associated with the/each support member.

A group of emergency lifting apparatuses may be configured to be activated in response to the same emergency signal. For example, a group of emergency lifting apparatuses may be controllably connected such that the emergency signal activates each of the group of emergency lifting apparatuses. The group may be associated with a same payload and/or a same first lifting apparatus and/or a same support member and/or a same lifting site (e.g. a vessel, deck or moonpool).

Different emergency lifting apparatuses may be activated in response to different emergency signals. For example, a first emergency signal may activate a first group of emergency lifting apparatuses, and a second emergency signal may activate a second group of emergency lifting apparatuses. The second emergency signal may relate to a second emergency event and/or to a second payload.

In particular embodiments the invention provides an emergency lift system for a floating vessel-mounting lifting apparatus to lift payloads a small distance clear of fixed seabed-mounted infrastructure should a winch fail to operate with the payload just above the fixed infrastructure. The emergency lift distance may be sufficient so the payload does not impact with the infrastructure as the vessel heaves up and down with the waves. The emergency lift system may be fully independent of the winch system. Three sheaves may flank a support wire somewhere along its normal routing on board the support vessel. In normal operations none of the sheaves may make contact with the wire, and hence do not have any effect on the long term fatigue life or lifting efficiency of the wire. In an emergency lift situation the middle sheave may travel perpendicular to the wire direction, pushing the wire into and between the two outer sheaves. Consequently the hanging load is lifted a small height, sufficient to clear it of all subsea structures, including due allowance for heaving of the vessel. The travel of the middle sheave may be powered by a hydraulic cylinder. The drive for the cylinder travel may be independent of the winch drive system. The drive for the cylinder travel may be fast acting such that the load is rapidly lifted above a height where it could otherwise collide with the fixed seabed infrastructure. The hydraulic supply to the cylinder may be from an HPU or accumulator system. The three sheaves and drive cylinder may be mounted together on an independent yoke structure. The net resultant external forces acting on the complete arrangement may be substantially zero; other than assembly weight. Thus no significant structural mounting may be required for the yoke.

The invention includes one or more corresponding aspects, embodiments or features in isolation or in various combinations whether or not specifically stated (including claimed) in that combination or in isolation. For example, it will readily be appreciated that features recited as optional with respect to the second aspect may be additionally applicable with respect to the other aspects without the need to explicitly and unnecessarily list those various combinations and permutations here.

In addition, corresponding means for performing one or more of the discussed functions are also within the present disclosure.

It will be appreciated that one or more embodiments/aspects may be useful in lifting a payload in an emergency, such as due to a failure of a first lifting apparatus.

The above summary is intended to be merely exemplary and non-limiting.

### BRIEF DESCRIPTION OF THE DRAWINGS

These and other aspects of the present invention will now be described, by way of example only, with reference to the accompanying drawings, in which:

FIG. 1 is a schematic view of a floating vessel with a moonpool deployment tower provided with emergency lifting apparatus in accordance with an embodiment of the present invention;

FIG. 2 is a perspective view of the lifting apparatus of FIG. 1;

FIG. 3 is an enlarged view of the lifting apparatus of FIG. 2, illustrating the apparatus in standby mode;

FIG. 4 illustrates the apparatus of FIG. 3 in activated mode; and

FIGS. 5 and 6 are schematic views of elements of the lifting apparatus of FIGS. 3 and 4.

### DETAILED DESCRIPTION OF THE DRAWINGS

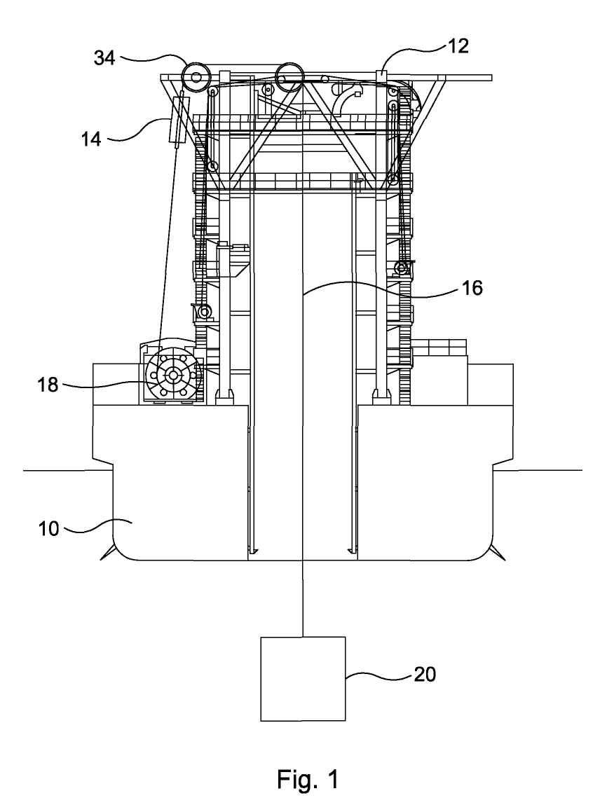

Reference is first made to FIG. 1 of the drawings, a schematic of a floating vessel 10 with a moonpool deployment tower 12 provided with emergency lifting apparatus 14 in accordance with an embodiment of the present invention. A wire 16 extends from the tower 12 to a payload 20. In this embodiment, the payload 20 is being lowered onto fixed sea-bed mounted infrastructure, such as a wellhead.

The vessel 10 and tower 12 may be equipped with a variety of sophisticated sensors and controls which stabilise the vessel 10 and adjust the tower 12 to ensure that the positioning of the payload 20 may be controlled as the vessel 10 is subject to movement. For example, if the payload 20 is to be lowered onto and then fixed to the sea-bed mounted infrastructure, uncontrolled movement of the payload 20 due to wave-induced motion of the vessel 10 would make the operation difficult and dangerous.

A winch 18 is provided on the tower 12 to control the height of the payload 20. Although shown with one winch 18, additional winch/es (not shown) may also be employed, such as subsea and/or other tower winch/es.

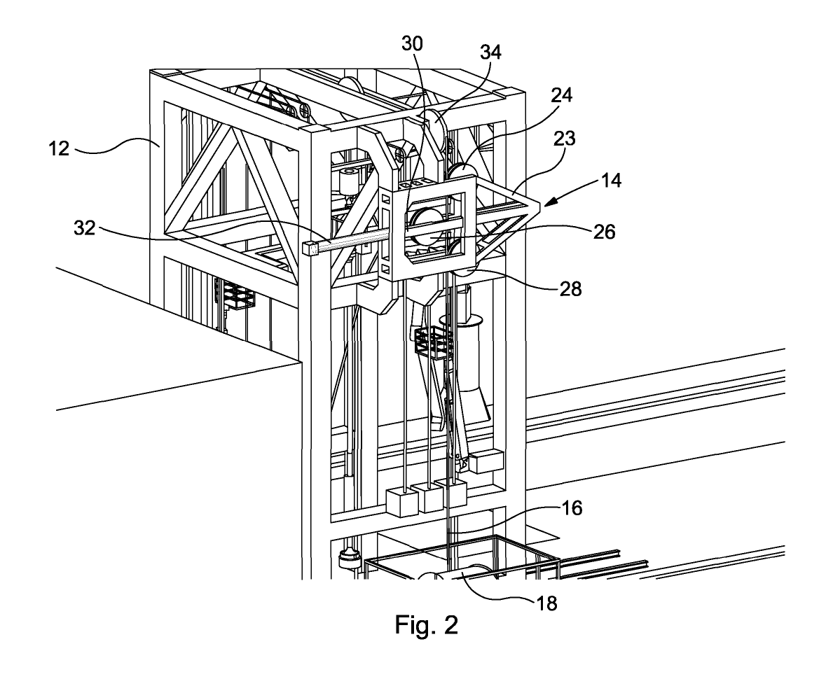

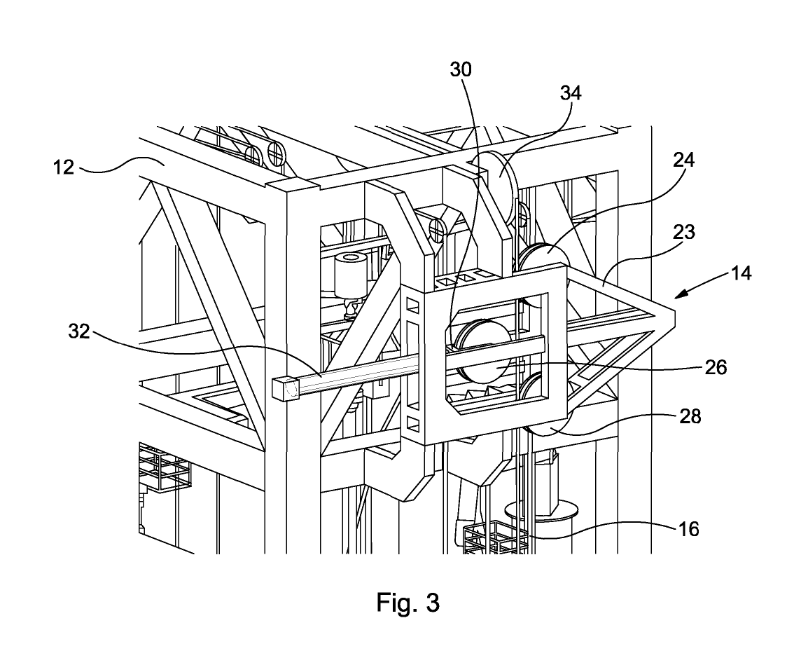

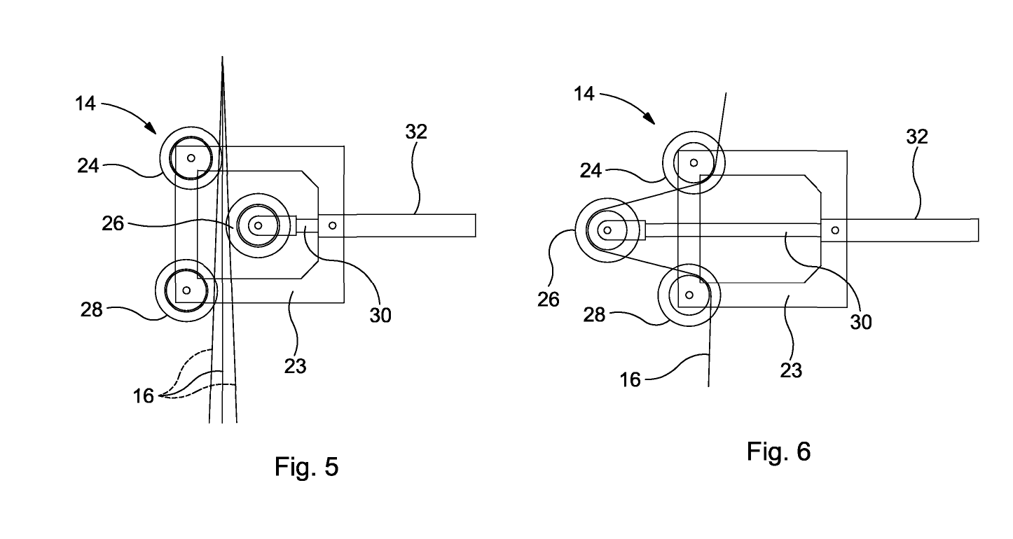

Reference is now made also to FIGS. 2 and 3 of the drawings, perspective views of the lifting apparatus 14 mounted on the upper side of the tower 12, showing only a portion of the wire 16. The wire 16, from the winch 18, passes through the apparatus 14. The apparatus 14 comprises a frame 23 which provides mounting for three sheaves 24, 26, 28. The upper and lower sheaves 24, 28 are rigidly mounted to one side of the wire portion 22, while the piston-mounted middle sheave 26 is mounted to the other side of the wire 16 on a piston 30. The piston 30 is housed in a cylinder 32 fixed in location on the frame 23. The frame 23 is mounted towards the top of the tower 12: this provides a maximum separation between the emergency lifting apparatus 14 and the winch 18. Accordingly, the deviation of the wire 16 in normal use, due to changes in position on the winch 18 (e.g. where the exit point of the wire 16 from the winch 18 varies along a winch drum as the wire 16 winds/unwinds), relative to the apparatus 14 is limited (as depicted by the dashed line 16 in FIG. 5). Thereby it is ensured that the wire 16 does not contact any of the sheaves 24, 26, 28 during normal operations.

The frame 23 shown here is mounted to the exterior of the tower 12, where mounting locations can be more readily accessible than on the interior of the tower 12, where other auxiliary equipment may be mounted. However, it will be appreciated that in other embodiments it may be appropriate to mount the emergency lifting apparatus 14 to the interior of the tower 12, or to the top of the tower 12.

The sheaves 24, 26, 28 are each independently freely rotatable about their central axis. Each sheave 24, 26, 28 is freely rotatable in response to a tensile force in the wire 16. Accordingly, the activation of the apparatus exerts a similar tensile force on the wire 16 in each direction (up and down). The net resultant vertical forces acting on the vessel 10 due to the emergency lifting apparatus is negligible (the wire 16 pulls the winch 18—and the vessel—upwards similarly hard as the wire 16 pulls the payload 20 upwards—and the vessel 10 downwards, due to the pulley system). Accordingly, the frame 23 can be relatively structurally lightweight, such as in comparison to the payload 20 and/or the winch 18.

FIG. 3 is an enlarged view of the lifting apparatus of FIG. 2, illustrating the apparatus 14 in standby mode. The travel of the middle sheave 26 is powered by the cylinder 32; which is a hydraulic cylinder 32 connected to an HPU or accumulator system (not shown). The drive for the cylinder 32 travel is independent of the winch 18. The cylinder 32 is fast acting such that the load 20 is rapidly lifted above a height where it can collide with a fixed seabed infrastructure.

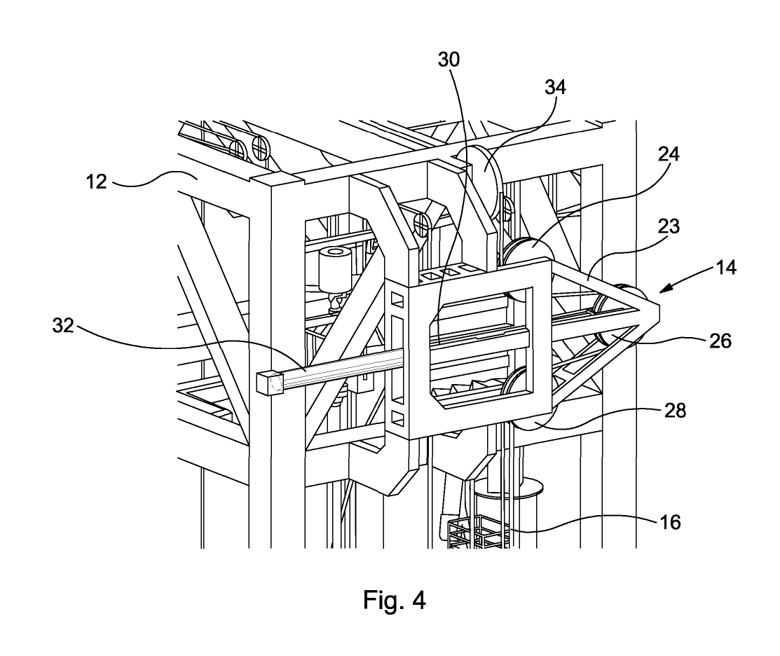

FIG. 4 illustrates the apparatus of FIG. 3 in activated mode. The piston 30 has been activated by the cylinder 32 such that the middle sheave 26 has been extended between the other sheaves 24, 28. The middle sheave 26 has displaced a portion of the wire 16 laterally. Thereby the wire 16 is pressed into contact with all three sheaves 24, 26, 28. The displaced portion of the wire 16 accounts for an increased length of path of the wire 16 from the winch 18 to the payload 20. Where the wire 16 is effectively anchored by the winch 18, the result is a net reduction in separation between the load 20 and the winch 18 (i.e. the load 20 is raised towards the vessel 10).

FIGS. 5 and 6 are schematics of elements of the lifting apparatus of FIGS. 3 and 4. The distance by which the load 20 is raised is determined by the change in length of path of the wire 16. Before activation, the wire travels through the apparatus 14 without contacting any of the sheaves 24, 26, 28. As can be seen in FIG. 5, the sheaves are suitably distant from the wire 16 for all paths of the wire 16 during winding/unwinding from the winch 18 (as indicated by the dashed lines 16). Accordingly, the wire passes in a straight line from the winch to a pulley 34 at the top of the tower 12 in normal use. Upon an emergency event, or anticipation of an emergency event, the emergency signal activates the cylinder 32 such that the middle sheave 36 is forced into contact with the wire 16 and forces the wire 16 into contact with the sheaves 24, 28. Thereby the wire 16 no longer passes in a straight line between the winch 18 and the pulley 34. Where the wire 16 is effectively anchored by the winch 18, the resultant increase in path length of the wire 16 causes the relative length of the wire on the payload-side of the apparatus 14 to be reduced. Accordingly, the load 20 is raised towards the vessel 10 by a distance corresponding to the increased path length of the wire 16 through the apparatus 14 in the activated configuration of FIG. 6.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. It should be understood that the embodiments described herein are merely exemplary and that various modifications may be made thereto without departing from the scope of the invention. For example, where the apparatus 14 has been mounted to the wire 16 on a winch side of a tower pulley system, in other embodiments the apparatus 14 may be mounted to the wire 16 on a payload side of the tower pulley system. Where the wire 16 shown here is directly connected to the payload 20, in other embodiments the apparatus 14 may be mounted to a control wire indirectly connected to the payload, such as by a further support wire (for example where multiple lifting apparatuses are used to lift a same payload).

1. A lifting method comprising:
supporting a payload using a first lifting apparatus;
activating an emergency lifting apparatus to raise the payload a predetermined distance in response to an emergency signal.

2. An emergency lifting apparatus for use in association with a first lifting apparatus for supporting a payload, the emergency lifting apparatus being configured to be activated to lift the payload a predetermined distance in response to an emergency activation signal.

3. The lifting apparatus of claim 2 wherein the lifting apparatus is mounted on a site which is subject to movement, such as a floating vessel.

4. The lifting apparatus of claim 2 wherein the lifting apparatus includes an elongate support.

5. The lifting apparatus of claim 2 wherein the first lifting apparatus is associated with one or more winches.

6. The lifting apparatus of claim 5 wherein the winch is a subsea winch.

7. The lifting apparatus of claim 2 wherein the emergency signal is generated automatically.

8. The lifting apparatus of claim 2 wherein the emergency signal is triggered by an operator in response to an observed or anticipated event.

9. The lifting apparatus of claim 2 wherein the apparatus is configured to act on a flexible elongate support, and on activation induces primarily vertical movement of the payload.

10. The lifting apparatus of claim 9 wherein the apparatus is configured to move a portion of the support to induce a shortening or retraction of the support between the apparatus and the payload.

11. The lifting apparatus of claim 9 wherein the apparatus induces a lateral deflection in a portion of the support, which deflection is accommodated by shortening of the support between the apparatus and the payload.

12. The lifting apparatus of claim 2 wherein the emergency lifting apparatus includes a support deflecting member which is actuatable to deflect a support member from an initial position.

13. The lifting apparatus of claim 12 wherein the deflecting member includes a sheave for contact with the support member.

14. The lifting apparatus of claim 13 wherein the sheave diameter is selected such that contact between the sheave and the support member does not damage the support member.

15. The lifting apparatus of claim 12 wherein the deflecting member is provided with a suitably shaped non-rotating surface.

16. The lifting apparatus of claim 12 wherein the deflecting member's contact surface for contacting the support if provided with a low-friction coating.

17. The lifting apparatus of claim 12 wherein the deflecting member is associated with an actuator.

18. The lifting apparatus of claim 17 wherein the actuator operates independently of the first lifting apparatus actuation.

19. The lifting apparatus of claim 17 wherein the actuator comprises a piston and cylinder arrangement.

20. The lifting apparatus of claim 12 wherein the support deflecting member is actuatable to move substantially transversely to the support member; such that the portion of the support member is laterally deflected.

21. The lifting apparatus of claim 12 wherein the apparatus is configured to prevent contact between the deflecting member/s and the support member/s during normal use.

22. The lifting apparatus of claim 12 wherein the deflecting member is provided in combination with one or more support member restraining members, or one or more further deflecting members, such that lateral deflection of the support member is translated efficiently to shortening or retraction of the support member between the lifting apparatus and the payload.

23. The lifting apparatus of claim 22 wherein the apparatus is configured to prevent contact between the restraining member/s and the support member/s during normal use.

24. The lifting apparatus of claim 22 wherein the apparatus is configured to press the support member against the restraining member/s by activation of the deflecting member/s.

25. The lifting apparatus of claim 22 wherein the apparatus comprises a liftside restraining member positioned to contact the support member at a position along the support member between the deflecting member and the first lifting apparatus upon activation of the emergency lifting apparatus.

26. The lifting apparatus of claim 22 wherein the apparatus comprises a payload-side restraining member positioned to contact the support member at a position along the support member between the deflecting member and the payload upon activation of the apparatus.

27. The lifting apparatus of claim 25 wherein the liftside and/or payload-side restraining member/s is/are configured to remain substantially stationary relative to the first lifting apparatus and/or the support during activation of the emergency lifting apparatus.

28. The lifting apparatus of claim 25 wherein the liftside and/or payload-side restraining member/s is/are configured to move relative to the first lifting apparatus and/or the support during activation of the emergency lifting apparatus.

29. The lifting apparatus of claim 22 wherein the restraining member/s include/s a sheave/s for contact with the support member.

30. The lifting apparatus of claim 22 wherein the deflecting member and the restraining member/s are positioned in a substantially vertical plane.

31. The lifting apparatus of claim 22 wherein the apparatus is configured to move the deflecting member adjacent the separating member/s upon activation.

32. The lifting apparatus of claim 22, wherein the apparatus comprises a liftside restraining member positioned to contact the support member at a position along the support member between the deflecting member and the first lifting apparatus upon activation of the emergency lifting apparatus wherein the apparatus comprises a payload-side restraining member positioned to contact the support member at a position along the support member between the deflecting member and the payload upon activation of the apparatus, and the apparatus is configured to move the deflecting member through a separation between the liftside and payload-side restraining members upon activation.

33. The lifting apparatus of claim 2 wherein the predetermined distance corresponds to a predetermined distance to compensate for a maximum potential emergency drop in payload height.

34. The lifting apparatus of claim 2 wherein the predetermined distance corresponds to a maximum emergency displacement of the support member.

35. The lifting apparatus of claim 34 wherein the maximum emergency displacement of the support member is due to a maximum heave and/or yaw and/or pitch and/or drift of a floating first lifting apparatus and/or a maximum unchecked support member payout from a failing first lifting apparatus prior to arresting the payout.

36. The lifting apparatus of claim 2 wherein the emergency lift system is fully independent of the first lifting apparatus.

37. The lifting apparatus of claim 2 wherein the emergency lift system is mounted on an independent support structure.

38. The lifting apparatus of claim 37 wherein the emergency lift apparatus net resultant external forces acting on the site is substantially limited to the weight of the emergency lifting apparatus and the independent support structure.

37-48. (canceled)
